(19) United States
(12) Patent Application Publication
(10) Pub. No.: US 2019/0266634 A1
(43) Pub. Date: Aug. 29, 2019

(54) On-line Shopping Cart Chat

(71) Applicant: Baruch AXELROD, Givat Shmuel (IL)

(72) Inventor: Baruch AXELROD, Givat Shmuel (IL)

(21) Appl. No.: 15/904,886

(22) Filed: Feb. 26, 2018

(51) Int. Cl. G06Q 30/02; G06F 9/54; G06Q 30/06; H04L 12/58; H04L 29/08

(52) U.S. Cl. CPC G06Q 30/0253; G06F 9/547; G06Q 30/0633; G06Q 30/0255; G06F 3/04842; G06Q 30/0269; H04L 51/046; H04L 67/306; G06Q 30/0613

(57) ABSTRACT

A computerized system and method of conducting an on-line shopping cart chat, the method comprising: receiving from an application programming interface (API) of an on-line shopping application an item selected by a user; communicating to the API an instruction to offer the user an iterative chat; presenting the user with a first question associated with the selected product and defined in a preset repository of questions and answers; receiving the user's response to said question; continuing to present the user with a different question based on the selected product and previous response, until the user selects to exit the chat; and responsively to receiving a response from the API of a user interest in a purchase offer of the iterative chat, presenting to the user a purchase offer of the appropriate item.

### FIELD OF THE INVENTION

The present invention is directed to systems and methods for on-line purchases.

### BACKGROUND

Successful salespeople in conventional stores often promote add-on sales after a customer has selected an initial item for purchase. On-line stores, by contrast, may display catalogue items that a customer might like based on prior selections. However, such “suggestions” are not engaging in an interactive sense and the overall sales process therefore is less effective.

### SUMMARY

Embodiments of the present invention provide systems and methods for engaging an on-line shopper in an add-on sales chat after the shopper has selected an initial item to purchase, according to an embodiment of the present invention.

According to an embodiment of the present invention, a system may include a computing system comprising: at least one processor; and at least one memory communicatively coupled to the at least one processor comprising computer-readable instructions that when executed by the at least one processor cause the computing system to implement a method of conducting an on-line shopping cart chat, the method comprising:

receiving from an application programming interface (API) of an on-line shopping application an item selected by a user;

communicating to the API an instruction to offer the user an iterative chat;

presenting the user with a first question associated with the selected product and defined in a preset repository of questions and answers;

receiving the user's response to the question;

continuing to present the user with a different question based on the selected product and previous response, until the user selects to exit the chat; and

responsively to receiving a response from the API of a user interest in a purchase offer of the iterative chat, presenting to the user a purchase offer of the appropriate item.

In some embodiments, the repository of questions and answers can be edited by a system administer.

In some embodiments, the repository of questions and answers is a spreadsheet.

In some embodiments, the user selects an item by adding it to the shopping cart or by clicking on a predetermined button.

In some embodiments, each question has 4 or less possible answers the user can select.

In some embodiments, presenting questions is also based on user profile information.

In some embodiments, the, wherein the user is offered a discount on purchasing multiple items.

In some embodiments, the user is offered a discount on purchasing two or more of the same item.

In some embodiments, the user is offered to purchase additional items based user responses.

In some embodiments, the user is offered promotional items based time of purchase, items selected or user profile information.

In another aspect, the present invention relates to a computerized method comprising at least one processor and at least one memory communicatively coupled to the at least one processor comprising computer-readable instructions that when executed by the at least one processor implement a method of conducting an on-line shopping cart chat, the method comprising:

receiving from an application programming interface (API) of an on-line shopping application an item selected by a user;

communicating to the API an instruction to offer the user an iterative chat;

presenting the user with a first question associated with the selected product and defined in a preset repository of questions and answers;

receiving the user's response to said question;

continuing to present the user with a different question based on the selected product and previous response, until the user selects to exit the chat; and

responsively to receiving a response from the API of a user interest in a purchase offer of the iterative chat, presenting to the user a purchase offer of the appropriate item.

The present invention will be more fully understood from the following detailed description of embodiments thereof.

### BRIEF DESCRIPTION OF DRAWINGS

The accompanying drawings illustrate embodiments of the disclosed subject matter and explain principles of embodiments of the disclosed subject matter. Structural details are shown only to the extent necessary for an understanding of the disclosed subject matter and the various ways in which it may be practiced.

FIG. 1 is a block diagram of a system for conducting an on-line shopping cart chat, according to an embodiment of the present invention.

FIG. 2 is a schematic, flow diagram of a process of conducting an on-line shopping cart chat, according to an embodiment of the present invention.

### DETAILED DESCRIPTION OF THE INVENTION

In the following detailed description of various embodiments, reference is made to the accompanying drawings that form a part thereof, and in which are shown by way of illustrating specific embodiments by which the invention may be practiced. It is understood that other embodiments may be envisioned and structural changes made without departing from the scope of the present invention.

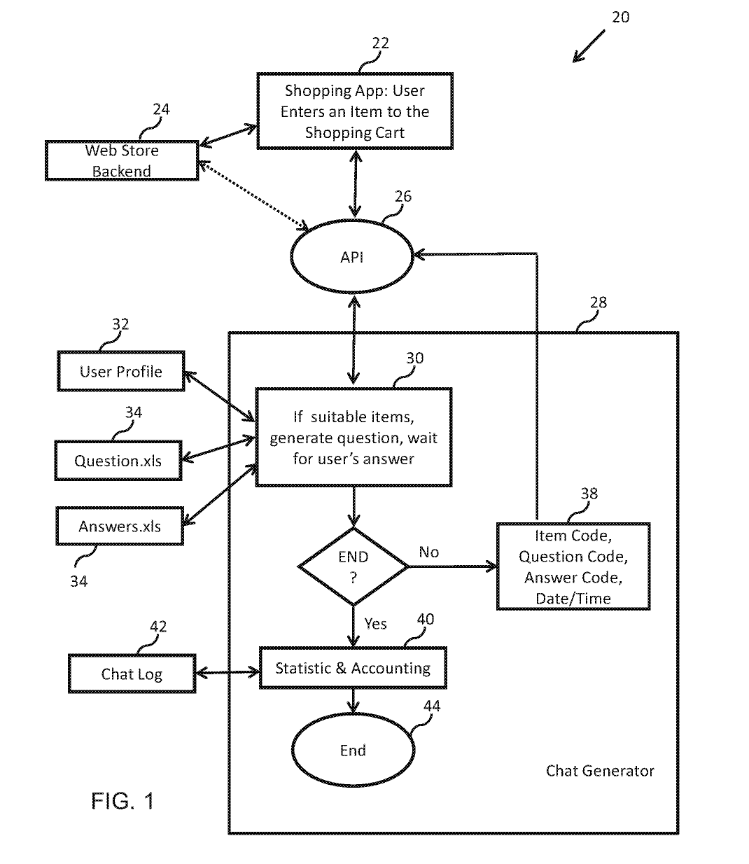

FIG. 1 is a block diagram of a system 20 for conducting an on-line shopping cart chat, according to an embodiment of the present invention. The term “chat” as referred herein relates to a chat generated by a machine (system 20) with the online shopper. An on-line shopping application 22 includes a user interface that presents items for purchase to a customer, referred to hereinbelow as a “user”. The interface is typically presented through a computing device such as a personal computer, a notebook computer, a tablet, a mobile device or any other personal computing device. The shopping application generally operates either as part of web site or as an application (also referred to as “app”) on the user personal device (mobile phone, computer, tablet etc.). Typically, the shopping application also includes a connection to a remote server-based backend application 24 of a web store, the back-end application typically being configured to maintain a catalog of products available for sale, as well as to process user purchase selections with automated tasks such as billing and routing shipping instructions to vendors. Typically, the shopping application also accesses the web store backend application to receive information regarding products that are available for sale by a vendor or operator of the web store.

In embodiments of the present invention, the shopping application includes an application programming interface (API) 26. The API 26 is typically invoked by the shopping application when a user reaches a “shopping cart page” of the shopping application or by any other notification method such as selecting a product and clicking on a predetermined button, for example, a “Get a Better Deal” button that when selected will invoke the API 26. The “shopping cart page” is a screen displaying all items that a user has selected for purchase. Alternatively, the API 26 may be invoked by the shopping application when a user indicates a desire to purchase a given item, but before the user navigates to the shopping cart page.

The API 26 is typically a distinct application or background process operating on the user device or in connection with the shopping site or application using a local or remote connection, for example, residing on the same server, communicating over the Internet or any other common connection methods between two software programs. The API 26 may include or invoke a chat generator 28, which similarly to the API 26 is typically a software-based processing engine.

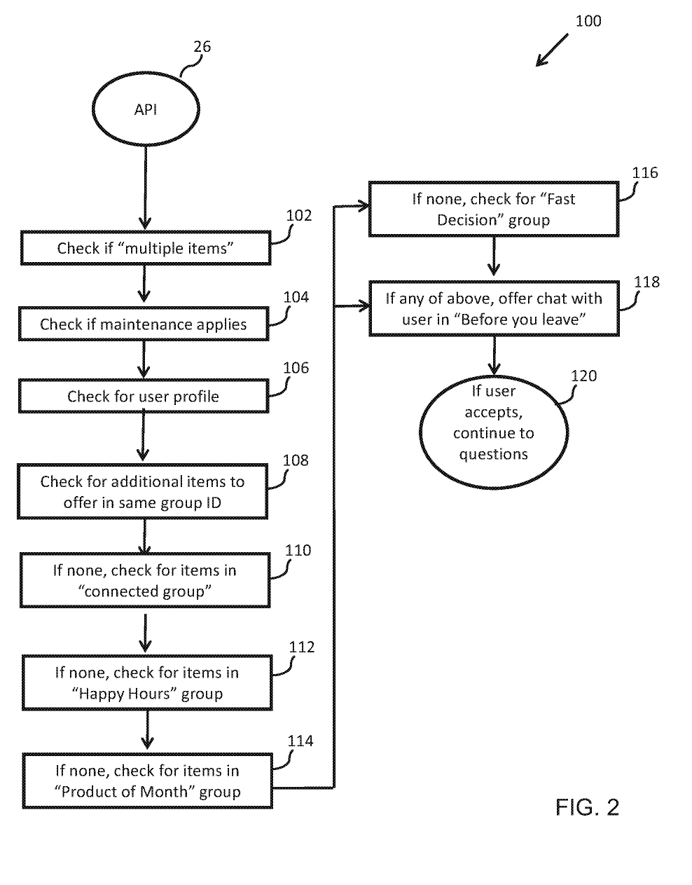

As indicated in FIG. 1, the chat generator 28 typically performs several iterative processing steps. The primary processing functions of the chat generator 28 are indicated as processing step 30. At this step, the chat generator 28 first determines if there are suitable additional items to present to the user, that is, items, or products, offered by the shopping application that may appeal to the user in addition to the item that the user has already selected in the shopping application. These additional items can be of several types, for example, related items (such as accessories of the selected product); quantity offer for the selected product (buy 3 shirts and get 15% discount); special offers (offer of the day/week. special offers to selected groups etc.); or items suggested by the system as relevant (like: users who bought this product also bought these products . . . ). The decision as to whether there are additional suitable items is based on a number of factors, as described further hereinbelow with respect to FIG. 2. To make the determination regarding additional items, the chat generator 28 may communicate with several additional processes and/or data repositories. These may include a user profile repository 32, which includes previously determined traits/history of the user, a questions repository 34, and an answers repository 34. In some embodiments, the question and answer repositories 34 may have the format of a spreadsheet, such as a spreadsheet in the format of a Microsoft Excel™ spreadsheet. Some or all of the repositories accessed may be stored as files on the user device or on a remote server accessible by remote communications to the user device. In some embodiments, the question and answer repositories are updated on a frequent basis by the operator of the shopping application or by a third party who provides the chat function of the chat generator 28, typically on behalf of the shopping application operator.

The questions repository 34 typically includes questions related to products and additional services, such as maintenance contracts, that may appeal to the user. The chat generator 28 selects from the repository 34 an initial question to pose a user, based on an initial determination of an appropriate item. Subsequently, based on the user's responses, that is, the user's answers to the question, the chat generator 28 selects additional questions to present to the user. Typically, questions present multiple choice questions, or questions with numeric answers. Questions are transmitted from the chat generator 28 to the API 26, which in turn communicates the questions to the user interface of the shopping application or to an additional screen, such as a “pop-up” screen appearing on the same physical interface, thereby permitting interaction and response from the user.

For each question, the user may provide an answer that leads to an additional question being presented by the chat generator 28, or the user may answer that he would prefer to end. If the user has not selected to end the process either by exiting or showing interest to purchase an item, then the chat generator 28 extracts the appropriate subsequent question from the question repository 34, typically with multiple choice answers extracted from the answer repository 34. At a step 38 the chat generator 28 transmits the selected question and answers to the API 26. Additionally, the chat generator 28 may transmit a code reflecting an item being offered, as well as a data/time timestamp. The API 26 communicates these parameters to the user interface, as described above. The number of iterations is limited by the pre-set number of iterations defined in the question repository 34. In addition, there may be a predefined fixed limit, such as a maximum of four questions. At any time, if the user accepts an offer to purchase on more additional items, these items (with the selected quantity and offered price) are added to the user's online shopping cart.

If the user decides to terminate the chat, then at a step 40, the chat generator 28 processes statistical and accounting details related to the chat interaction for subsequent statistical analysis and transaction verification. This data can be stored in a chat log 42 which may be local or remote. The data can also be transmitted to the remote web store backend.

As described above, the question and answer repositories 34 may be configured as one or more spreadsheets. The spreadsheet interface is well understood by relatively non-technical operators. Consequently, non-technical vendors, who maintain on-line shops that provide little flexibility by default, can add the chat functionality of the present invention without having to use sophisticated programming methods.

FIG. 2 is a schematic, flow diagram of a process 100 of conducting an on-line shopping cart chat, according to an embodiment of the present invention. Process 100 is a sub-process that precedes the main iterative process of processing step 30 of the chat generator 28 described above. Process 100 determines if the chat generator 28 will prompt the user to begin a chat.

At a first step 102, the chat generator 28 may determine if the user's order qualifies for a discount based on multiple items being ordered. If the question repository 34 is formatted as a spreadsheet, the multiple item discount levels may be set as a pair of columns, one indicated a range of a number of items, the second being the percent discount warranted.

If the multi-item discount is warranted, the chat generator 28 may skip the subsequent steps of process 100, jumping to step 118, at which the chat generator 28 conveys to the API 26 an instruction to present a chat offer to the user. Each subsequent step of process 100 operates in a similar manner. If the chat generator 28 makes a positive determination regarding a type of question that is suitable to ask, the chat generator 28 jumps to step 118 to offer the user a chat. If not, a subsequent type of “check” is performed. If all steps are performed and none provide a positive determination of a type of offer to make, the process ends without making an offer.

For example, if the multi-item discount is not available (either not configured in the repository 34, or the user has a single item order), then the chat generator 28 continues to step 104, checking if, according to the repository 34 the item chosen by the user can be accompanied by an extended maintenance contract.

At a step 106, the chat generator 28 may refer to a preset user profile 32, which may indicate user characteristics that may guide the selection of subsequent questions. The profile may indicate features such as age and sex.

At a step 108, the chat generator 28 then may check whether the repository has been configured to offer additional items in a group ID that matches the item selected by the user. For example, if the on-line shop sells books, then book groups may be defined by the vender according to genre. If the user has selected a book from the fiction genre, the question repository 34 may be set to indicate additional fiction books that are appropriate to offer.

If there are no items in the same group, at a step 110 the chat generator 28 may check if there are suitable “connected group” items. A connected group may be any group defined by the vendor as being connected to the group of the user's selected item. For example, a connected group to a book of fiction may be a video of a work of fiction.

If there are no suitable items to offer in a connected group, at a step 112 the chat generator 28 may check if the question repository 34 is set to offer items according to a “happy hours” group, based on the time of day of the order. For example, the repository 34 may be set to offer a specific set of items at a given discount, such as 10%, if the order takes place between 5 pm and 6 pm. The “happy hour” may also be set according to additional time parameters, such as day of week or day of month.

If there are no items in the happy hour group, at a step 114 the chat generator 28 may check if there are suitable “product of the month” items, that is, items set to be offered during the course of a given month, typically with a special discount. Similar groups may be defined as a “product of the week” or “product of the day”.

An additional type of group, if there are no items in the product of month group, may be a “fast decision” group, check at a step 116. This would include items offered if the user makes a decision within a limited amount of time, such as half-a-minute.

As described above, if any of the above checks determines that there is an appropriate offer to make to the user, the chat generator 28 jumps to step 118, at which the API 26 is notified to ask the user if he would like to see special offers. If the user accepts, then at a step 120, the chat generator 28 continues to the iterative operation of step 30 described above with respect to FIG. 1.

It is to be understood that elements of the system and process described above may be combined in different combinations in different embodiments of the present invention. Processing elements of the system may be implemented in digital electronic circuitry, or in computer hardware, firmware, software, or in combinations thereof. Such elements can be implemented as a computer program product, tangibly embodied in an information carrier, such as a non-transient, machine-readable storage device, for execution by, or to control the operation of, data processing apparatus, such as a programmable processor, computer, or deployed to be executed on multiple computers at one site or distributed across multiple sites. Memory storage may also include multiple distributed memory units, including one or more types of storage media. Examples of storage media include, but are not limited to, magnetic media, optical media, and integrated circuits such as read-only memory devices (ROM) and random access memory (RAM). The system may have one or more processors and one or more network interface modules. Processors may be configured as a multi-processing or distributed processing system. Network interface modules may control the sending and receiving of data packets over networks.

Method steps associated with the system and process can be rearranged and/or one or more such steps can be omitted to achieve the same, or similar, results to those described herein. It is to be understood that the embodiments described hereinabove are cited by way of example, and that the present invention is not limited to what has been particularly shown and described hereinabove. Rather, the scope of the present invention includes variations and modifications thereof which would occur to persons skilled in the art upon reading the foregoing description and which are not disclosed in the prior art.

1. A computing system comprising:
at least one processor; and
at least one memory communicatively coupled to the at least one processor comprising computer-readable instructions that when executed by the at least one processor cause the computing system to implement a chat generator for conducting an on-line shopping cart chat, wherein the chat generator is a process comprising the steps of:
receiving, from an application programming interface (API) of an on-line shopping application, a notice of a product selected by a user;
communicating to the API an instruction to offer the user an iterative chat;
generating a first question of the iterative chat, wherein the first question includes one or more first offers associated, according to associations defined in a preset repository of multiple choice questions and answers, with the selected product and with one or more of a time of an order and of a characteristic of user profile information;
receiving a first response of the user to the first question;
responsively to the first response, generating an additional question of the iterative chat from the preset repository, and continuing to generate subsequent questions of the iterative chat from the preset repository, after each subsequent response of the user, until the user selects to exit the iterative chat, wherein the subsequent questions include further offers that are associated in the preset repository with the selected product, with the time of the order, with the user profile information, and with the user's first and subsequent responses; and
responsively to receiving a response from the API of a user selection of at least one of the first and the further offers presented in the respective first and subsequent questions by the iterative chat, communicating with the API to add, to a shopping cart of the on-line application, an item indicated by the user's offer selection.

2. The system of claim 1, wherein said repository of questions and answers is accessible for editing by a system administer.

3. The system of claim 2, wherein said repository of questions and answers is a spreadsheet.

4. The system of claim 1, wherein the user selects the product in the shopping application by adding it to the shopping cart or by clicking on a predetermined button on a webpage of the shopping application presenting the product.

5. The system of claim 1, wherein each question has 4 or less possible answers the user can select.

6. (canceled)

7. The system of claim 1, wherein at least one of the first or the further offers includes a discount on purchasing multiple items.

8. The system of claim 1, wherein at least one of the first or the further offers includes a discount on purchasing two or more of the same item.

9. The system of claim 1, wherein at least one of the first or the further offers includes a discount for purchasing additional items, wherein the discount is based on at least one of the user's responses to the interactive chat, and wherein the association of the discount with the at least one of the user's responses is defined in the preset repository.

10. The system of claim 1, wherein at least one of the first or the further offers includes promotional items, wherein the promotional items are associated in the preset repository with the time of the order, with items selected by the user, and with the user profile information.

11. A computerized method of conducting an on-line shopping cart chat, implemented by at least one processor and at least one memory communicatively coupled to the at least one processor and comprising computer-readable instructions that when executed by the at least one processor implement the method comprising:
receiving at a chat generator, from an application programming interface (API) of an on-line shopping application, a notice of a product selected by a user;
communicating from the chat generator, to the API, an instruction to offer the user an iterative chat;
generating at the chat generator a first question of the iterative chat, wherein the first question includes one or more first offers associated, according to associations defined in a preset repository of multiple choice questions and answers, with the selected product and with one or more of a time of an order and of a characteristic of user profile information;
receiving, at the chat generator, a first response of the user to the first question;
responsively to the first response, generating at the chat generator an additional question of the iterative chat from the preset repository, and continuing to generate subsequent questions of the iterative chat from the preset repository, after each subsequent response of the user, until the user selects to exit the iterative chat, wherein the additional and subsequent questions include further offers that are associated in the preset repository with the selected product, with the time of purchase, with the user profile information, and with the user's first and subsequent responses; and
responsively to receiving at the chat generator a response from the API of a user selection of at least one of the first and the further offers presented in the respective first and subsequent questions by the iterative chat, communicating with the API to add, to a shopping cart of the on-line application, an item indicated by the user's offer selection.

12. The system of claim 1, wherein said repository of questions and answers is accessible for editing by a system administer.

13. The system of claim 2, wherein said repository of questions and answers is a spreadsheet.

14. The system of claim 1, wherein the user selects the product in the shopping application by adding it to the shopping cart or by clicking on a predetermined button on a webpage of the shopping application presenting the product.

15. The system of claim 1, wherein each question has 4 or less possible answers the user can select.

16. (canceled)

17. The system of claim 1, wherein at least one of the first or the further offers includes a discount on purchasing multiple items.

18. The system of claim 1, wherein at least one of the first or the further offers includes a discount on purchasing two or more of the same item.

19. The system of claim 1, wherein at least one of the first or the further offers includes a discount for purchasing additional items, wherein the discount is based on at least one of the user's responses to the interactive chat, and wherein the association of the discount with the at least one of the user's responses is defined in the preset repository.

20. The system of claim 1, wherein at least one of the first or the further offers includes promotional items, wherein the promotional items are based on the time of purchase, items selected and the user profile information, and wherein the association of the promotional items with the at least one of the user's responses is defined in the preset repository.

21. A computerized method of conducting an on-line shopping cart chat, implemented by at least one processor and at least one memory communicatively coupled to the at least one processor and comprising computer-readable instructions that when executed by the at least one processor implement the method comprising:
receiving to a spreadsheet file, through a spreadsheet user interface, one or more offers by a vendor of an on-line store and further receiving associations of those offers with products of the on-line store, with times of orders, and with characteristics of user profile information;
receiving at a chat generator, from an application programming interface (API) of an on-line shopping application providing a user interface to the on-line store, a notice of a product selected by a customer;
communicating from the chat generator, to the API, an instruction to offer the customer an iterative chat;
generating at the chat generator a first question of the iterative chat, wherein the first question includes one or more first offers associated, according to the associations defined in the spreadsheet file, with the selected product and with one or more of a current time of the order and profile information of the customer;
receiving, at the chat generator, a first response of the customer to the first question;
responsively to the first response, generating an additional question of the iterative chat from the preset repository, and continuing to generate subsequent questions of the iterative chat from the preset repository, after each subsequent response of the user, until the customer selects to exit the iterative chat, wherein the subsequent questions include further offers that are associated in the preset repository with the selected product, with the time of the order, with the user profile information, and with the customer's first and subsequent responses; and
responsively to receiving at the chat generator a response from the API of a selection by the customer of at least one of the first and the further offers presented by the iterative chat, communicating with the API to add, to a shopping cart of the on-line application, an item indicated by the customer's offer selection.
